(19) United States
(12) Patent Application Publication
(10) Pub. No.: US 2025/0381699 A1
(43) Pub. Date: Dec. 18, 2025

(54) DEFLECTING DEVICE FOR SEPARATING AND DRAWING OFF A MATERIAL WEB

(71) Applicant: OPTIMA life science GmbH, Schwäbisch Hall (DE)

(72) Inventors: Philipp Winterer; Johannes Jansen, Schwäbisch Hall (DE); Karl-Heinz Halder, Schwäbisch Hall (DE)

(73) Assignee: OPTIMA life science GmbH, Schwäbisch Hall (DE)

(21) Appl. No.: 18/877,721

(22) PCT Filed: Jun. 20, 2023
(86) PCT No.: PCT/EP2023/066565

§ 371 Date: Dec. 20, 2024

(30) Foreign Application Priority Data
Jun. 21, 2022 (DE) 102022206200.0

(51) Int. Cl. B26D 3/28; B32B 38/10

(52) U.S. Cl. CPC B26D 3/282; B32B 38/10

(57) ABSTRACT

The invention relates to a deflecting device for separating and peeling off a second material web (4) from a multilayer material web (1), comprising a die-cut first material web (2a) with die-cutting waste (2b) and the second material web (4), wherein the deflecting device (7) has a first deflecting contour (71) over which the second material web (4) is passable for separating and peeling off the second material web (4) from the die-cut first material web (2a), wherein the deflecting device (7) has a second deflecting contour (72) over which the second material web (4) is passable for deflecting a front edge (20b) of die-cutting waste (2b), and wherein the second deflecting contour (72) is not the same as the first deflecting contour (71). The invention further relates to a device and to a method for separating and peeling off a material web from a multilayer material web.

### TECHNICAL FIELD AND PRIOR ART

The invention relates to a deflecting device for separating and peeling off a material web from a multilayer material web. The invention further relates to a device and to a method for separating and peeling off a material web from a multilayer material web.

It is known to build up products and intermediate products having two or more layers by lamination of material webs using a web processing method and/or web processing device. Lamination refers, in connection with the application, both to a temporary or permanent connection of one material web to one or more further material webs or blanks, and to a usually temporary connection of one material web to another material web used as, for example, a carrier web or protective film. A multilayer material web is also referred to as a laminate. Separating and peeling off a material web from a laminate is, in connection with the application, also referred to as delamination.

Multilayer material webs are known as finished products or intermediate products for a plurality of applications, for example the manufacture of an emergency bandage or the manufacture of a membrane structure, for example for fuel cells or electrolyzers, or the manufacture of parts thereof.

Single webs or all material webs may be provided with penetrations or cutouts having different functions.

It is for example known to manufacture a Membrane Electrode Assembly (MEA) or parts thereof, for a fuel cell or for an electrolyzer, from material webs. The MEA comprises a Catalyst Coated Membrane, abbreviated to CCM, on which subgaskets, frames or rims are provided on one or both sides, and which are made of less expensive and more resistant material. It is also known to provide a material web for the frames, wherein cutouts for windows are made in the material web and the CCM is connected to the material web such that an active area is arranged in the windows and a rim of the active area of the CCM is covered by areas surrounding said windows.

In other designs, further or different cutouts are to be made in material webs for frames or other layers, alternatively or additionally to windows, which form channel structures or openings for connections in a later material composite.

The cutouts are made using known methods by die-cutting, in particular by rotary die-cutting. Other cutting methods are however also conceivable. The cuts delimiting the cutouts are referred to, in connection with the application, as die-cutting contours, regardless of the cutting method used. Material webs with die-cutting contours are referred to as die-cut material webs.

It is known in this context to laminate the material web with a protective film for die-cutting or other cutting methods. Die-cutting or cutting is performed here such that die-cutting contours are made in the material web, by which the material web, but not the protective film, is cut through. The protective film thus ensures sufficient stability of the material web during and after die-cutting or other cutting. The cutouts or the waste delimited by the die-cutting contours are referred to as die-cutting waste, in connection with the application, regardless of the cutting method used.

It is furthermore known in this context to delaminate, i.e. separate and peel off the protective film used in die-cutting from the material web after said die-cutting.

The die-cutting waste usually has to be removed in one step together with the delamination of the protective film from the material web. For delamination of the protective film, devices are known with deflecting elements, such as deflecting rollers or deflecting wedges, around which the protective film is deflected.

### OBJECT AND SOLUTION

The object of the invention is to provide a deflecting device and a device and method for reliable separation and peeling off of a second material web with die-cutting waste from a die-cut multilayer material web.

This object is solved by the subject matters with the features of claims 1, 4 and 8. Advantageous embodiments result from the dependent claims.

In accordance with a first aspect, a deflecting device is provided for separating and peeling off a second material web from a multilayer material web, which comprises a die-cut first material web with die-cutting waste and the second material web, wherein the deflecting device has a first deflecting contour over which the second material web is passable for separating and peeling off the second material web from the die-cut first material web, and wherein the deflecting device has a second deflecting contour over which the second material web is passable for deflecting a front edge of die-cutting waste, wherein the second deflecting contour is not the same as the first deflecting contour.

In connection with the application, the terms “a” or “an” are generally used as the indefinite articles and not as “one” in the numerical sense. The terms “first” and “second” used in connection with the application also serve only to distinguish, and not to indicate any sequence. Also, the term “first” does not necessarily require the existence of second identical or similar elements.

The deflecting device with two different deflecting contours provides a reliable option within the process for separating and peeling off the second material web from the die-cut first material web by use of a deflecting device, possibly without deflection of the die-cut first material web, or with deflection and reliable detachment of the die-cutting waste.

This is important in particular during the manufacture of MEAs in which, in a subsequent process step, function elements for example have to be positioned with high precision relative to windows in the first material web which are exposed after removal of the die-cutting waste from said first material web.

The first and the second deflecting contour are here suitably designable by the person skilled in the art, depending on the use case. Since it is in particular the transitions that are critical in methods for separating and peeling off a second material web from a multilayer material web, where separating and peeling off operations of the second material web without die-cutting waste and with die-cutting waste alternate, the deflecting contours are in each case selected in advantageous designs, such that it is ensured by the first deflecting contour that edges of the die-cut material web which abut the die-cutting waste in the transport direction are not detached, and such that it is ensured by the second deflecting contour that a front edge of the die-cutting waste is separated with the second material web from the first material web in the transport direction.

In an embodiment, it is provided for this purpose that the first deflecting contour is wedge-shaped and the second deflecting contour is circular-arc-shaped. The wedge-shaped design permits deflection at an acute angle for the deflection of the second material web, wherein the first material web is held in the transport direction at the same time. If, however, a die-cutting waste to be detached reaches the first deflecting contour, its heavily curved effective face can result in the die-cutting waste to be detached not following with its front edge the path of the second material web, but instead being peeled off the latter and remaining on the first material web. The circular-arc-shaped second deflecting contour by contrast allows detachment with a large curvature radius, whereby the die-cutting waste is reliably deflected with the second material web.

The deflecting device combines here the properties of a deflecting roller and of a deflecting wedge in a single device. In an embodiment, the deflecting device is designed single-part as a deflecting element, wherein the first or the second deflecting contour is movable into a respective usage position depending on the orientation of the deflecting element. These usage positions are the same or different depending on the use case. The deflecting contours are provided on a circumference of the single-part deflecting element. In an embodiment, the deflecting contours are selected such that surfaces delimiting the wedge-shaped first deflecting contour tangentially abut the circular-arc-shaped second deflecting contour. The deflecting device is, in another embodiment, designed multi-part, wherein parts of the deflecting device are movable relative to one another, so that the first or the second deflecting contour is movable into the respective usage position depending on the arrangement of the deflecting device parts.

In an embodiment, it is provided that the first deflecting contour has a first curvature radius and the second deflecting contour a second curvature radius, wherein the first curvature radius is smaller than the second curvature radius. A small first curvature radius may be selected small, so that a wedge-shaped deflecting edge is created. The second curvature radius may by contrast be selected such that a deflecting contour comparable with a deflecting roller is created.

In accordance with a second aspect, a device is provided for separating and peeling off a second material web from a multilayer material web, comprising a die-cut first material web with die-cutting waste and the second material web, wherein the device has a deflecting device with a first deflecting contour and a second deflecting contour, wherein the deflecting device is mounted to be at least partially movable between a first position and a second position, in order to optionally pass the second material web over the first deflecting contour for separating and peeling off the second material web from the die-cut first material web, or over the second deflecting contour for deflecting a front edge of die-cutting waste.

As set forth above, the deflecting device is in one or more parts depending on the embodiment, wherein in the case of a multi-part design, in an embodiment only individual elements are moved in order to optionally bring the first or the second deflecting contour into action.

In an embodiment, it is provided that the deflecting device or parts thereof is/are mounted to be rotatable about a rotary axis between the first position and the second position. The rotary axis is in an embodiment arranged coaxially to a center of curvature of the second circular-arc-shaped deflecting contour. In an embodiment the rotary movement is limited to a back-and-forth movement over a defined angular range. In other embodiments, a rotary movement about 360° is possible. In an embodiment, the second deflecting contour is provided on a driven or stationarily arranged roller or on a stationary runner over which the web glides, and the first deflecting contour is provided on a component mounted movably relative to the roller. The component is, in an embodiment, mounted rotatably about a rotary axis arranged coaxially to a central axis of the roller.

In an embodiment, an actuator is provided for an adjusting movement of the deflecting device. This actuator is, depending on the use case, designed for example as a pneumatic, hydraulic and/or electric-motor actuator. The actuator is in some embodiments operable such that the deflecting device is moved alternatingly into the first position and second position, wherein in particular the deflecting device is moved such that at the beginning of a separating and peeling off operation of the second material web without die-cutting waste, or of a separating and peeling off operation of the second material web with die-cutting waste, the deflecting device is arranged in the first and in the second position respectively, wherein the deflecting device is moved into the second position or the first position respectively during the separating and peeling off operation.

In an embodiment, the multi-layer material web has on its side opposite the second material web a transport web which is laminated after the die-cutting contours have been made on the first material web and which stabilizes the first material web after peeling off of the second material web.

In another embodiment, a transport element, in particular a vacuum transport element, is provided, wherein the multilayer material web is placeable onto the transport element upstream of the deflecting device with one side opposite the second material web. The transport element is used here for stabilization. The transport element is designed, depending on the use case, as a continuous conveyor belt or roller.

In accordance with a third aspect, a method is provided for separating and peeling off a second material web from a multilayer material web, which comprises a die-cut first material web with die-cutting waste and the second material web, by use of a deflecting device with a first deflecting contour and with a second deflecting contour, wherein the deflecting device is moved at least partially between a first position and a second position, in order to optionally pass the second material web over the first deflecting contour for separating and peeling off the second material web from the die-cut first material web, or over the second deflecting contour for deflecting a front edge of die-cutting waste. The method thus permits a reliable delamination within the process of the second material web with the die-cutting waste, without any unwanted deformation of the first material web.

In an embodiment, it is provided that the deflecting device or parts thereof is/are rotated about a rotary axis between the first position and the second position.

In an embodiment, it is provided that separating and peeling off operations of the second material web without die-cutting waste and with die-cutting waste alternate with one another, wherein the deflecting device is moved alternatingly into the first position and the second position. A movement is performed in some embodiments by an actuator. In an embodiment, it is provided that the deflecting device is moved such that at the beginning of a separating and peeling off operation of the second material web without die-cutting waste the deflecting device is arranged in the first or the second position, and at the beginning of a separating and peeling off operation of the second material web with die-cutting waste the deflecting device is arranged in the second position, and wherein during the separating and peeling off operation the deflecting device is moved into the second position or the first position respectively.

### BRIEF DESCRIPTION OF THE DRAWINGS

Further advantages and aspects of the invention can be found in the claims and in the description of an example of the invention that is explained in the following on the basis of the schematic figures. The peeling shows schematically in:

FIG. 1: a multilayer material web comprising a first and a second material web with an adhesive layer between them;

FIG. 2: an intermediate product comprising the die-cut first material web of the multilayer material web according to FIG. 1 after separating and peeling off the second material web from the first material web together with window cutouts of the first material web;

FIG. 3: an example of a device comprising a deflecting device for separating and peeling off a material web from a die-cut multilayer material web;

FIG. 4: a deflecting device for separating and peeling off a material web from a die-cut multilayer material web in a first position; and

FIG. 5: the deflecting device according to FIG. 4 in a second position.

### DETAILED DESCRIPTION OF THE EXAMPLES

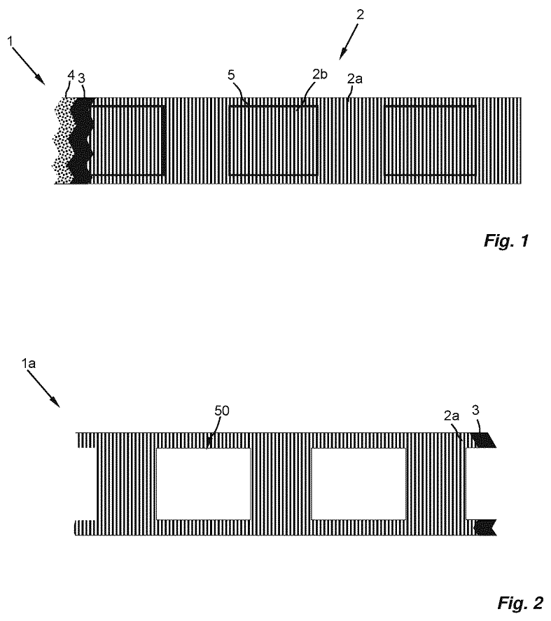

FIG. 1 shows schematically a multilayer material web 1 comprising a first material web 2 and a second material web 4 connected thereto by an adhesive layer 3.

The first material web 2 is here for example a for-use film, which is protected by the second material web 4 designed as a masking film. The term ‘film’ is used here for any homogeneous material webs which are made from plastic, metal or other materials or material mixes, depending on the use case.

An adhesive of the adhesive layer 3 is for example designed as a heat-activatable adhesive which is melted on in a later laminating process in order to connect the first material web 2, designed as the for-use film, to other elements and thereby form a laminate. The adhesive layer 3 is selected here such that it has, at room temperature too, a certain adhesive effect and is thus able to hold the second material web 4, designed as a masking film, on the first material web 2.

In accordance with FIG. 1, die-cutting contours 5 for window cutouts, which are removed in a subsequent step, are made in the first material web 2. The window cutouts to be removed are referred to as die-cutting waste 2b. Making window cutouts is required for example during production of MEAs for fuel cells. An area of the first material web 2 without the die-cutting waste 2b is referred to as the die-cut first material web 2a.

In some embodiments, the die-cutting contours 5 are created with suitable die-cutting devices (not shown), comprising for example rotary or flat die-cutters. For a die-cutting process and subsequent processing, it may be advantageous to design the die-cutting device such that cutting does not penetrate through all the layers of the multilayer material web 1, but is limited to one material web or (in the case of multilayer material webs with more than two material webs to some of the material webs), for example the first material web 2 designed as the for-use film and the adhesive layer 3. This simplifies the die-cutting process, since the die-cutting depth through the second material web 4 arranged on an opposite side of the die-cutter, in particular a masking film underneath, does not have to be as precisely selected as for cutting through all material webs. Also, the second material web 4 which is not cut through stabilizes the die-cut first material web 2a during conveying out of the die-cutting device to further process stations.

To connect the die-cut first material web 2a, designed for example as a for-use film, to blanks or other material webs in a subsequent process, the second material web 4, designed as the masking film, with the die-cutting waste 2b is to be separated and peeled off, i.e. delaminated, from the die-cut first material web 2a.

FIG. 2 shows an intermediate product 1a comprising the die-cut first material web 2a of the multilayer material web 1 according to FIG. 1 after separating and peeling off the second material web 4 from the die-cut first material web 2a. Separating and peeling off is performed together with the die-cutting waste 2b of the first material web 2, so that the die-cut first material web 2a has windows 50 after the second material web 4 has been peeled off. In the example shown, the adhesive layer 3 remains on the die-cut first material web 2.

The product 1a thus created is for example an intermediate product which undergoes further processing in further process steps to manufacture MEAs for fuel cells.

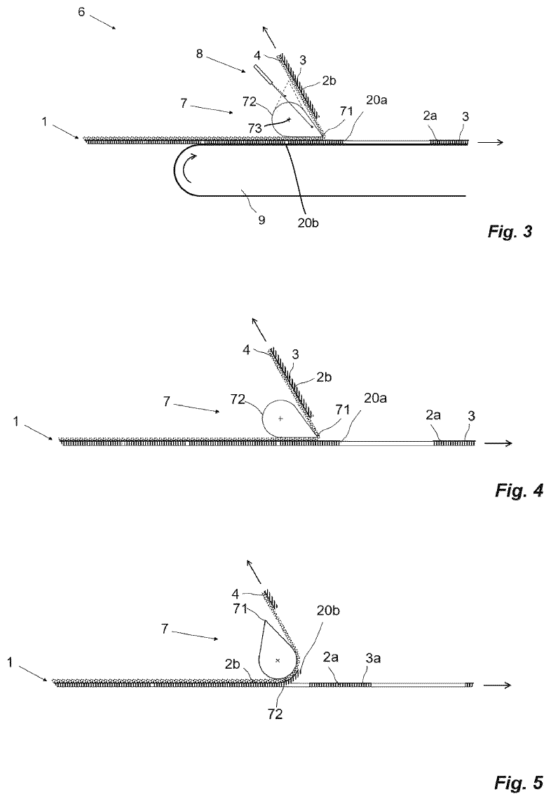

FIG. 3 shows a device 6 for separating and peeling off the second material web 4 from a multilayer material web 1, wherein the multilayer material web 1 comprises a die-cut first material web 2a with die-cutting waste 2b and the second material web 4.

The device 6 shown in FIG. 3 comprises a deflecting device 7 over which the second material web 4 is passed for separation and peeling off; an actuator 8; and a transport element 9 designed as a transport belt, in particular as a vacuum transport belt.

The deflecting device 7 has a first deflecting contour 71, over which the second material web 4 is passable, as shown in FIG. 3, for separating and peeling off the second material web 4 from the die-cut first material web 2a. The first deflecting contour 71 is, in the example shown, wedge-shaped and has a very small first curvature radius. The design is suitably selectable by the person skilled in the art depending on the use case, ensuring that a separation of the second material web 4 is also reliably achieved at a transversely extending edge 20a of the window 50 (cf. FIG. 3) without deformation of the first material web 2.

If, however, a die-cutting waste 2b reaches the first deflecting contour 71, its heavily curved effective face can result in the die-cutting waste 2b not following with its front edge 20b the route of the second material web 4 for separation and peeling off, but instead being peeled off the latter and remaining on the transport element 9.

The deflecting device 7 therefore also has a second deflecting contour 72, over which the second material web 4 is passable for deflecting a front edge 20b of die-cutting waste 2b. The design of the second deflecting contour 72 is suitably selectable by the person skilled in the art depending on the use case, so that a front edge 20b of die-cutting waste 2b reliably follows the route of the second material web 4 for separation and peeling off.

For that purpose, the second deflecting contour 72 is, in the example shown, circular-arc-shaped and has a second curvature radius which is substantially larger than the first curvature radius.

The deflecting device 7 is mounted rotatably between a first position shown in FIG. 3, in which the second material web 4 is passed over the first deflecting contour 71 for separating and peeling off the second material web 4 from the die-cut first material web 2a, and a second position shown by a dashed line in FIG. 3, in which the second material web 4 is passed over the second deflecting contour 72 for deflecting a front edge 20b of die-cutting waste 2b.

FIG. 4 shows the deflecting device 7 in a first position for separating and peeling off the second material web 4 from the die-cut first material web 2a, and FIG. 5 shows the deflecting device 7 in a second position for deflecting the front edges 20b of the die-cutting waste 2b.

The deflecting device 7 is, in the example shown, designed as a rod-like element with a teardrop-shaped cross-section. The element as a whole is mounted rotatably about a rotary axis 73 extending transversely to the movement direction of the multilayer material web 1 between a first position shown in FIGS. 3 and 4 and a second position shown in FIG. 3 (as a dashed line) and in FIG. 5.

In an alternative embodiment, the deflecting device 7 comprises two or more elements movable relative to one another, wherein said elements are movable relative to one another in order to optionally pass the second material web 4 over the first deflecting contour 71 for separating and peeling off the second material web 4 from the die-cut first material web 2a, or over the second deflecting contour 72 for deflecting a front edge 20b of die-cutting waste 2b.

Due to the die-cutting contours 5 made at regular intervals (cf. FIG. 1), separating and peeling off operations of the second material web 4 without die-cutting waste 2b alternate with separating and peeling off operations of the second material web 4 with die-cutting waste.

The deflecting device 7 is moved here such that at the beginning of a separating and peeling off operation of the second material web 4 without die-cutting waste 2b, or of a separating and peeling off operation of the second material web 4 with die-cutting waste 2b, the deflecting device 7 is arranged in the first or the second position, and wherein during the separating and peeling off operation the deflecting device is moved into the second position (cf. FIG. 5) or the first position (cf. FIG. 4) respectively.

In the example shown in FIG. 3, an actuator 8 is provided for an adjusting movement of the deflecting device 7. The actuator 8 is shown schematically in FIG. 3 by an extendable cylinder. In other embodiments, a driven rotary axis 73 is provided, which is arranged in the center of the arc of the second contour 72.

In some embodiments of the device 6, the actuator 8 is designed as a pneumatic or as an electric-motor actuator which is operated depending on a web position, in order to optionally pass the second material web 4 over the first deflecting contour 71 for separating and peeling off the second material web 4 from the die-cut first material web 2a, or over the second deflecting contour 72 for deflecting a front edge of die-cutting waste.

The multilayer material web 1 is placed on the transport element 9 with one side opposite the second material web 4 to be peeled off for stabilization upstream of the deflecting device 7. The transport element 9 shown is designed as a transport belt, in particular as a vacuum transport belt. In another embodiment, the transport element 9 is designed as a roller, in particular as a vacuum roller which is at least partially wrapped around by the multilayer material web 1.

1. A deflecting device for separating and peeling off a second material web from a multilayer material web, comprising a die-cut first material web with die-cutting waste and the second material web, wherein the deflecting device has a first deflecting contour over which the second material web is passable for separating and peeling off the second material web from the die-cut first material web, wherein the deflecting device has a second deflecting contour over which the second material web is passable for deflecting a front edge of die-cutting waste, wherein the second deflecting contour is not the same as the first deflecting contour.

2. The deflecting device according to claim 1, wherein the first deflecting contour is wedge-shaped and the second deflecting contour is circular-arc-shaped.

3. The deflecting device according to claim 1, wherein the first deflecting contour has a first curvature radius and the second deflecting contour a second curvature radius, wherein the first curvature radius is smaller than the second curvature radius.

4. A device for separating and peeling off a second material web from a multilayer material web, comprising a die-cut first material web with die-cutting waste and the second material web, wherein the device has a deflecting device according to claim 1, with a first deflecting contour and a second deflecting contour, wherein the deflecting device is mounted to be at least partially movable between a first position and a second position, in order to optionally pass the second material web over the first deflecting contour for separating and peeling off the second material web from the die-cut first material web, or over the second deflecting contour for deflecting a front edge of die-cutting waste.

5. The device according to claim 4, wherein the deflecting device or parts thereof is/are mounted to be rotatable about a rotary axis between the first position and the second position, wherein in particular the rotary axis is arranged coaxially to a center of curvature of the second circular-arc-shaped deflecting contour.

6. The device according to claim 4, wherein an actuator is provided for an adjusting movement of the deflecting device.

7. The device according to claim 4, wherein a transport element, in particular a vacuum transport element, is provided, wherein die multilayer material web is placeable onto the transport element upstream of the deflecting device with one side opposite the second material web.

8. A method for separating and peeling off a second material web from a multilayer material web, comprising a die-cut first material web and the second material web, by use of a deflecting device according to claim 1, with a first deflecting contour and a second deflecting contour, wherein the deflecting device is moved at least partially between a first position and a second position, in order to optionally pass the second material web over the first deflecting contour for separating and peeling off the second material web from the die-cut first material web, or over the second deflecting contour for deflecting a front edge of die-cutting waste.

9. The method according to claim 8, wherein the deflecting device or parts thereof is/are rotated about a rotary axis between the first position and the second position.

10. The method according to claim 8, wherein separating and peeling off operations of the second material web from the first material web without and with die-cutting waste alternate with one another, wherein the deflecting device is moved alternatingly into the first position and second position, wherein in particular the deflecting device is moved such that at the beginning of a separating and peeling off operation the deflecting device is arranged in the first and in the second position respectively, and wherein the deflecting device is moved into the second position or the first position respectively during the separating and peeling off operation.
